(19) United States
(12) Patent Application Publication
(10) Pub. No.: US 2018/0034647 A1
(43) Pub. Date: Feb. 1, 2018

(54) SYSTEMS AND METHODS TO REDUCE POWER CONSUMPTION IN DATA CENTERS

(71) Applicant: KEYSIGHT TECHNOLOGIES, INC., Loveland, CO (US)

(72) Inventor: Doug Baney, Santa Clara, CA (US)

(21) Appl. No.: 15/221,260

(22) Filed: Jul. 27, 2016

(51) Int. Cl. H04L 12/12; H04L 25/02; H04L 12/931

(52) U.S. Cl. CPC H04L 12/12; H04L 49/40; H04L 25/0272

(57) ABSTRACT

Methods and systems to reduce power consumption in data centers are disclosed. For example, a system includes a network switch configured to communicate high bandwidth communications to one or more servers. The system also includes one or more mode-suppressing coaxial cables coupling the network switch to the one or more servers. The one or more mode-suppressing coaxial cables are also configured to transport the high bandwidth communications between the network switch and the one or more servers.

### TECHNICAL FIELD

The presently disclosed subject matter relates to data centers. Particularly, the presently disclosed subject matter relates to systems and methods to reduce power consumption in data centers.

### BACKGROUND

As Internet services such as cloud computing and content distribution networks (CDNs) continue to expand, power consumption within data centers will continue to grow. Per the Nation Resource Defense Council (NRDC), approximately 91 billion kilowatt-hours of power were consumed by U.S. data centers in 2013. Current projections estimate U.S. data centers will increase annual power consumption to approximated 141 billion kilowatt-hours by 2020. These data centers are continuously pressured from a business perspective to keep up with newest technology developments that increase overall computing resources, communication bandwidth while minimizing power dissipation. Power dissipation increases data center operating costs through energy consumption and the requirement of facility equipment and location to remove unwanted heat. An example of undesirable heat generation is the power lost in converting electrical signals to optical signals and back to electrical signals again to overcome the well-known bandwidth limitations of electrical cables. The loss is due to inefficiencies in laser sources, optical coupling to the laser sources, cooling of the laser sources, encoding electrical signals on the optical carrier, and photodetection and amplification in photo receivers to return an electrical signal. Therefore, there is a need for improved systems and techniques for reducing power consumption in data centers while meeting the demand for technology developments.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods and systems to reduce power consumption in data centers are disclosed herein. According to an aspect, a system includes a network switch configured to communicate high bandwidth communications to one or more servers. The system also includes one or more mode-suppressing coaxial cables that couple the network switch to the one or more servers. Transverse-magnetic (TM) modes and transverse electric (TE) modes are suppressed above a cutoff frequency and along the entire length of each coaxial cable.

In another aspect, a cable assembly is configured to communicate high bandwidth communications between a network switch and a server. The cable assembly includes first and second adapter modules each configured to couple with a communication port of at least one of the network switch and the server. A first plurality of mode-suppressed coaxial cables is coupled between the first adapter module and amplifiers. A second plurality of mode-suppressed coaxial cables is coupled between the amplifiers and the second adapter module. Each of the amplifiers is a low noise amplifier and is configured to provide roll-off compensation.

### BRIEF DESCRIPTION OF TIRE DRAWINGS

The illustrated embodiments of the disclosed subject matter may be best understood by reference to the drawings, wherein like parts are designated by like numerals throughout. The following description is intended only by way of example, and simply illustrates certain selected embodiments of devices, systems, and processes that are consistent with the disclosed subject matter as claimed herein.

FIG. 1 is a top perspective view of a mode-suppressing coaxial cable 100 in accordance with embodiments of the present disclosure.

FIG. 2 is a cross-sectional end view of a passive coaxial ribbon cable 200 in accordance with embodiments of the present disclosure.

FIG. 3 is a schematic diagram of an active coaxial ribbon cable 300 configured to transport high bandwidth communications in a differential form in accordance with embodiments of the present disclosure.

FIG. 4 is a schematic diagram of a cable assembly 400 configured to communicate high bandwidth communications between a network switch and a server in accordance with embodiments of the present disclosure.

FIG. 5 is a schematic diagram of a system 500 in accordance with embodiments of the present disclosure.

### DETAILED DESCRIPTION

In the following detailed description, for purposes of explanation and not limitation, representative embodiments disclosing specific details are set forth in order to provide a thorough understanding of the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatuses and methods may be omitted so as to not obscure the description of the example embodiments. Such methods and apparatuses are clearly within the scope of the present teachings.

The terminology used herein is for purposes of describing particular embodiments only, and is not intended to be limiting. The defined terms are in addition to the technical and scientific meanings of the defined terms as commonly understood and accepted in the technical field of the present teachings. As used in the specification and appended claims, the terms ‘a’, ‘an’ and ‘the’ include both singular and plural referents, unless the context clearly dictates otherwise. Thus, for example, ‘a device’ includes one device and plural devices.

The described embodiments relate to data centers. Particularly, the presently disclosed subject matter relates to methods and systems to reduce power consumption in data centers. One specific technology with high power consumption is fiber optic interconnects used between routers, network switches, and servers within the data center. These fiber optic interconnects provide high bandwidth communications between servers and also between servers and one or more Wide Area Networks (WANs) associated with the data center.

Currently Ethernet and INFINEBAND™ are the most implemented types of fiber optic interconnects. Regarding Ethernet, the Institute of Electrical and Electronics Engineers (IEEE) standards organization recently approved 802.3bm-2015-“IEEE Standard for Ethernet-Amendment 3: Physical Layer Specifications and Management Parameters for 40 Gb/s and 100 Gb/s Operation over Fiber Optic Cables,” the standard of which is incorporated herein by reference in its entirety. Of specific interest, this standard defines an optical module supporting 100 Gb/s Ethernet to be used with a 100 Gigabit Attachment Unit Interface (CAUI-4) communication port. The CAUI-4 communication port supports four lanes of 25 Gb/s differential data for a 100 Gb/s Ethernet connection. For cable distances up to five meters, a quad twinax cable solution is available. From five to 100 meters an optical module using a multimode laser with multimode fiber optic cable is available. Most connections within data centers are greater than five meters and require using the optical module. Typical optical modules available for this application require approximated 3.5 watts of power each.

Also, network switches have become available supporting up to 36 CAVI-4 ports in a single rack unit (RU). Using an industry standard 7-foot 19-inch rack, over 1500 physical data connections may be supported. In this scenario, the data connections alone consume over 5000 watts of power for the single rack. Typically data centers have been designed to support approximately 100 to 200 watts per square foot of floor space. This equates to approximately 5000 watts per cabinet or rack. Some percentage of data centers have gone as high as 28,000 watts per cabinet. Above this limit, water cooling is required.

Specific power intensive components within these optical modules include lasers, laser power supplies, and thermoelectric coolers to maintain laser power and wavelength stability. Often laser reliability is a key issue in data centers. As such, redundant components or fiber optic interconnects may be required adding even more power consumption to the data center.

Using coaxial cables at distances greater than 5 meters is one solution to reduce power consumption and improve reliability. In a typical coaxial cable, a transverse electromagnetic (TEM) mode of wave propagation is preferred for signal transmission. The TEM mode includes both electric and magnetic field lines that are restricted to be transverse (i.e. normal) to the direction of wave propagation. As such, the TEM mode has a propagation velocity over frequency that is substantially dependent on a dielectric material of the coaxial cable. However, the typical coaxial cable also includes transverse-magnetic (TM) modes and transverse electric (TE) modes that are present above cutoff frequencies associated with these higher order modes. The TE modes, TM modes, and the cutoff frequency are dependent on the diameter and dielectric material and receive power coupled out of the desired TEM mode via cable perturbations such as radial cable bends or non-idealities in the cable structure. The TE and TM modes also have variable propagation velocities and can recouple to the desired TEM mode resulting in degradation of the desired TEM signal. This results in reduction in TEM transmitted power at frequencies where the other order TIE and TM modes are above their cutoff frequency. As such, the effective bandwidth for signal transmission is limited to frequencies below the cutoff frequency of the TE and TM modes. For the above reasons, higher bandwidth operation required conversion to optics or to additional lower bandwidth electrical cables with added cost and power dissipation.

To address the above limitation, this disclosure proposes using mode-suppressing coaxial cables. TM modes and TE modes are suppressed above a cutoff frequency and along the entire length of each coaxial cable.

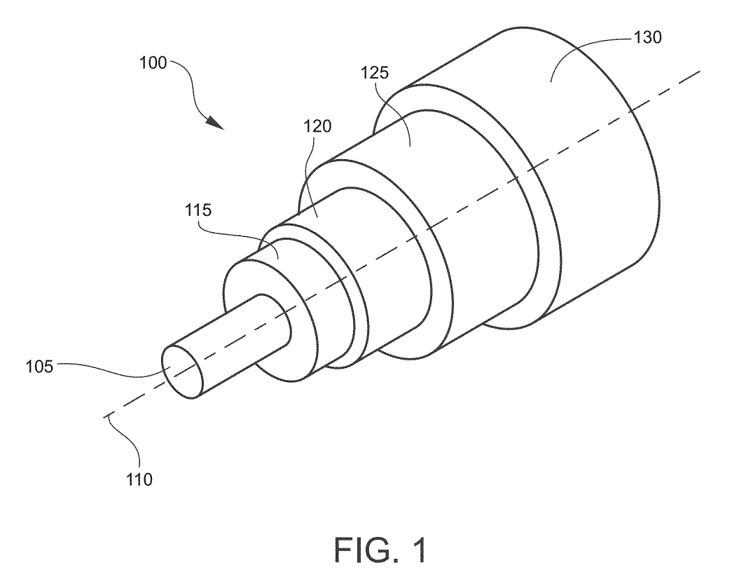

FIG. 1 illustrates a top perspective view of a mode-suppressing coaxial cable 100 in accordance with embodiments of the present disclosure. The mode-suppressing coaxial cable 100 comprises an inner electrical conductor 105 positioned along a common propagation axis 110, an inner dielectric material 115, an electrically thin resistive layer 120, an outer dielectric material 125, and an outer electrical conductor 130. The electrically thin resistive layer 120 is configured to attenuate TE and TM modes above the cutoff frequency along the entire propagation axis 110 while minimally affecting the TEM mode. As such, the effective bandwidth of the mode-suppressing coaxial cable 100 is extended above the cutoff frequency.

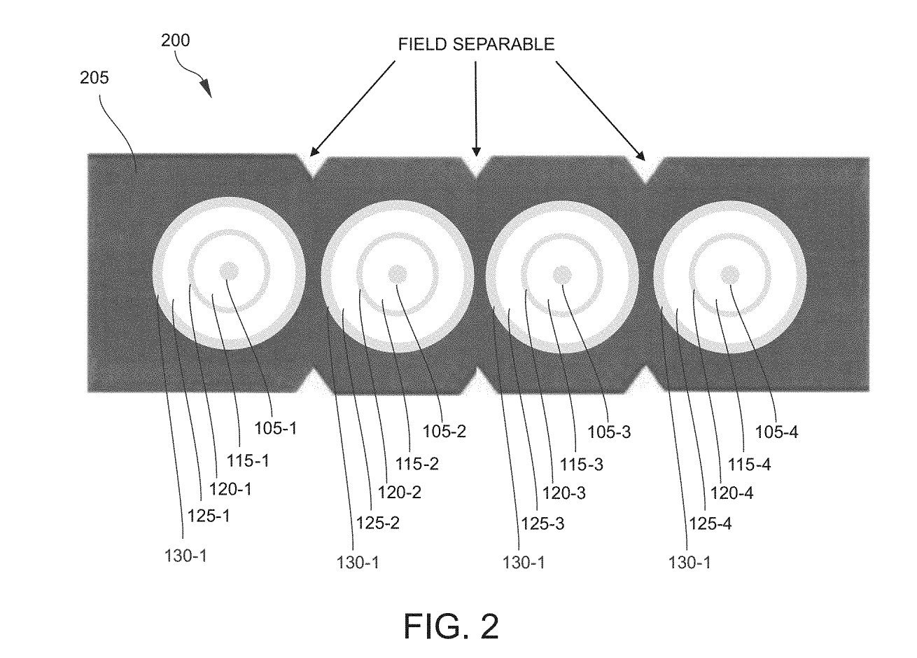

FIG. 2 illustrates a cross-sectional end view of a passive coaxial ribbon cable 200 in accordance with embodiments of the present disclosure. The passive coaxial ribbon cable 200 comprises four mode-suppressing coaxial cables 100 encased within an insulator structure 205. The insulator structure 205 may provide a separable ribbon format. In other embodiments, the separable ribbon format are field separable. The passive coaxial ribbon cable 200 is configured to utilize resistive mode suppression to extend bandwidth. In other embodiments, the passive coaxial ribbon cable may comprise more or less than four mode-suppressing coaxial cables 100.

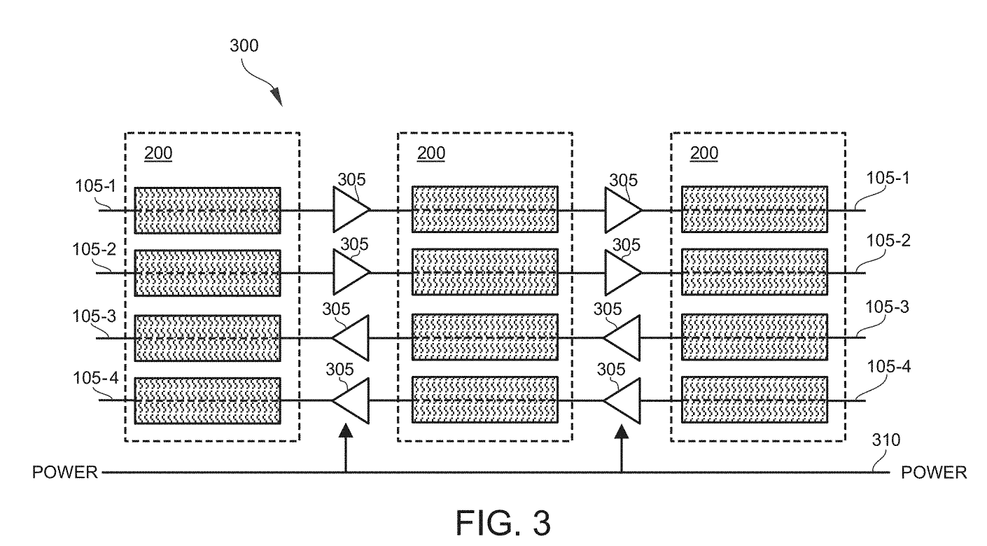

FIG. 3 illustrates a schematic diagram of an active coaxial ribbon cable 300 configured to transport high bandwidth communications in a differential form in accordance with embodiments of the present disclosure. The differential form may reduce signal noise associated with the transport of the high bandwidth communications. The active coaxial ribbon cable 300 includes three passive ribbon cables 200 coupled in series with amplifiers 305. The active coaxial ribbon cable 300 is configured to supply power to the amplifiers 305. The supplied power may be direct current (DC) power. One or more of the passive coaxial ribbon cables 200 may have electrical supply lines for the supplied power. In other embodiments, one or more mode-suppressing coaxial cables 100 may be used for the supplied power.

In other embodiments, the amplifiers 305 are configured to compensate for signal loss associated with the transport of the high bandwidth communications. The amplifiers 305 may be low power dissipation amplifiers. Each amplifier 305 may include roll-off compensation circuitry that is configured to boost higher frequencies that have been attenuated over the passive coaxial ribbon cable 200. In other embodiments, two amplifiers 305 may be implemented as a single differential amplifier.

In other embodiments, additional coaxial ribbon cables 200 maybe coupled in series to extend a length of the active coaxial ribbon cable 300. Additional amplifiers 305 may be used for the coupling. In other embodiments, only two passive coaxial ribbon cables 200 maybe coupled in series.

In other embodiments, the active coaxial ribbon cable 300 may be configured to transport high bandwidth communications in in single-ended form.

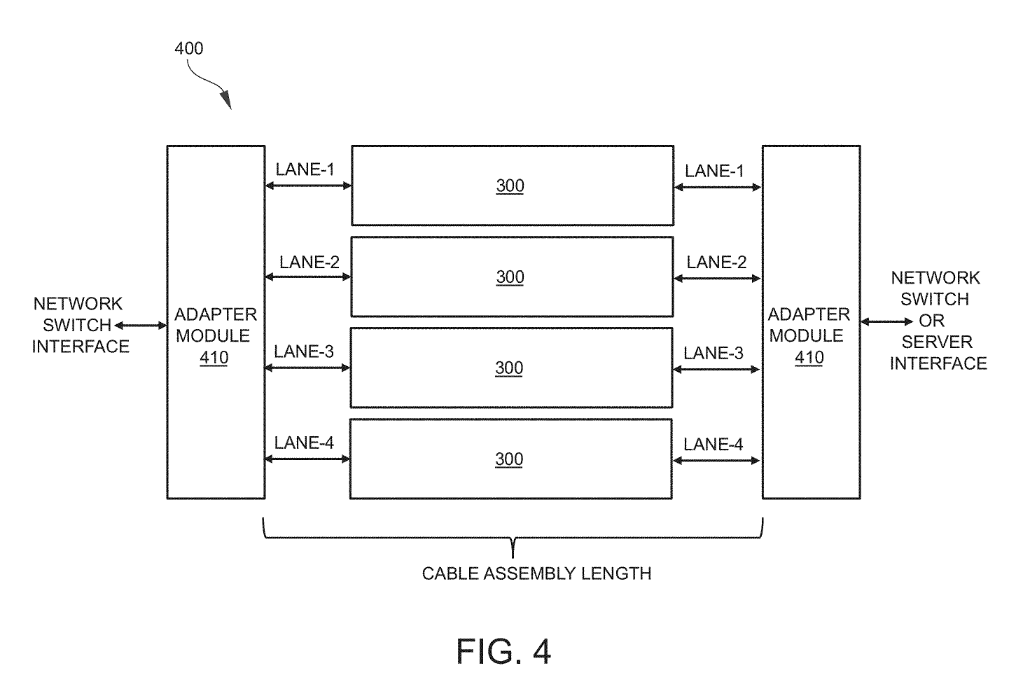

FIG. 4 illustrates a schematic diagram of a cable assembly 400 configured to communicate high bandwidth communications between a network switch and a server in accordance with embodiments of the present disclosure. The cable assembly includes first and second adapter modules 410 each configured to couple with a communication port of at least one of the network switch and the server. The cable assembly 400 also includes four active coaxial ribbon cables 300. In other embodiments, more or less than four active coaxial ribbon cables 300 may be used. Each active coaxial ribbon cable 300 supports a lane, wherein a lane is a differential directional signal path. In other embodiments the first and second adapter modules 410 may be configured to be compliant with an INFINIBAND™ communications port. In other embodiments, the first and second adapter modules 410 may be configured to be compliant with an Ethernet port.

In other embodiments, the cable assembly 400 may be configured to provide at least one of a 10 Gb/s, a 40 Gb/s, a 100 Gb/s, a 200 Gb/s, or a 400 G/s IEEE 802 compliant Ethernet connection. The cable assembly 400 may be compliant to a CAUI-4 communications port.

In other embodiments, the cable assembly 400 may be configured to provide a Double Data Rate (DDR) INFINIBAND™ connection at an aggregated data rate of at least one of 20 Gb/s, 40 Gb/s, or 60 Gb/s.

In other embodiments, the cable assembly 400 may be configured to provide a Quadruple Data Rate (QDR) IINFINIBAND™ connection at an aggregated data rate of at least one of approximately 10 Gb/s, 40 (Gb/s, 80 (Gb/s, or 120 Gb/s.

In other embodiments, the cable assembly 400 may be configured to provide a Fourteen Data Rate (FDR) INFINIBAND™ connection at an aggregated data rate of at least one of approximately 14 Gb/s, 56 Gb/s, 112 Gb/s, or 168 GB/s.

In other embodiments, the cable assembly 400 may be configured to provide a Enhanced Data Rate (EDR) INFINIBAND™ connection at an aggregated data rate of at least one of approximately 26 Gb/s, 104 Gb/s, 208 Gb/s, or 312 GB/s.

In other embodiments, the cable assembly 400 may be configured to provide a High Data Rate (HDR) INFIINIBAND™ connection at an aggregated data rate of at least one of approximately 50 Gb/s, 200 Gb/s, or 600 Gb/s.

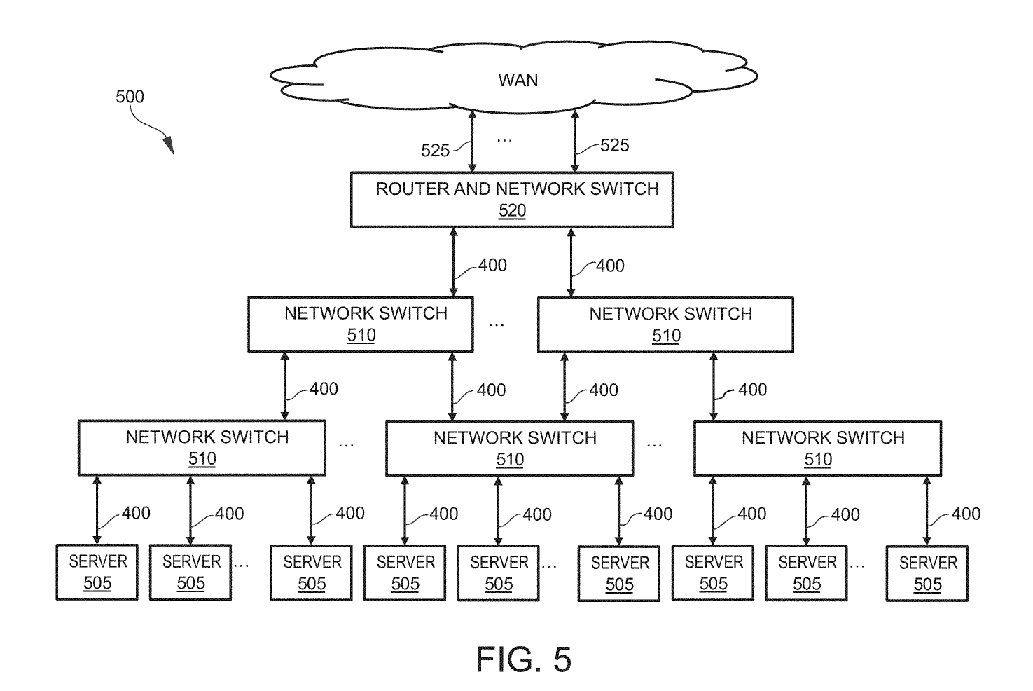

FIG. 5 illustrates a schematic diagram of a system 500 in accordance with embodiments of the present disclosure. The system 500 may be incorporated within a data center. The system 500 includes servers 505 and network switches 510. The system also includes a combination router and network switch 520 coupled with a wide area network (WAN). The WAN may be the Internet. Cable assemblies 400 provide intra-connectivity within the system 500. One or more fiber optic interconnects 525 provide connectivity between the combination router and network switch 520.

In other embodiments, the cable assembly 400 may be configured to transport 8b/10b encoded differential data or 64b/66b encoded differential data for each lane.

In other embodiments, the first adapter module 405 may be further configured to detect a data rate for one or more lanes. The adapter module may be further configured to control roll-off circuitry of one or more amplifiers 305 based on the detected data rate.

In other embodiments for added reliability, a combination of a router and network switches 520 may be implemented and cross-connected between one or more network switches 510. The network switches 510 may also be cross-connected between each other. In other embodiments, the servers 505 may have network switches 510 implemented within their network interface cards (NICs). The NICs may be cross-wired with additional network switches 510.

In other embodiments, one or more of the cable assemblies 400 may transport high bandwidth communications having a network protocol stack. The network protocol stack may have a link layer, The link layer may be an Ethernet layer or an INFINIBAND™ (IB) layer. In other embodiments. The link layer may also be an asynchronous transfer mode (ATM) layer.

In other embodiments, at least one of the cable assemblies 400 transports high bandwidth communications having an RDMA over Converged Ethernet (RoCE) network protocol. In other embodiments, one or more of the cable assemblies 400 transports high bandwidth communications having an internet wide area RDMA protocol (MARI)) network protocol.

In other embodiments, system 500 may include a software defined network (SDN). The network switches 510 may also be managed switches. One or more the network switches 510 may be a managed network switch coupled with an SDN controller using one or more of the cable assemblies 400.

In other embodiments the WAN may be a private WAN. The private WAN may be a corporate WAN interconnecting remote corporate sites. In other embodiments, the private WAN may be used by a multiple-system operator (MSO) delivering cable TV (CATV) services and digital phone services. In other embodiments, the WAN may be a public WAN owned by an MSO and be used to deliver subscriber based Internet access over at least one of Data Over Cable Service Interface Specification (DOCSIS), digital subscriber line (DSL), Wi-LAN, cellular access, or satellite.

In other embodiments, the system 500 may provide network attached storage (NAS) via the WAN. In other embodiments, the system 500 may provide leased cloud based services, in other embodiments, the system 500 may be implemented within a content distribution network (CDN) and provide storage for the CDN.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Therefore, the embodiments disclosed should not be limited to any single embodiment, but rather should be construed in breadth and scope in accordance with the appended claims.

What is claimed is:

1. A system, comprising;
a network switch configured to communicate high bandwidth communications to one or more servers; and
one or more mode-suppressing coaxial cables coupling the network switch to the one or more servers, the one or more mode-suppressing coaxial cables configured to transport the high bandwidth communications between the network switch and the one or more servers.

2. The system of claim 1, wherein the one or more mode-suppressing coaxial cables are configured to utilize resistive mode suppression to transport the high bandwidth communications.

3. The system of claim 1, wherein the one or more mode-suppressing coaxial cables are configured to utilize one of single-ended form and differential form to transport the high bandwidth communications.

4. The system of claim 3, wherein the one of single-ended form and differential form reduces signal noise associated with the transport of the high bandwidth communications.

5. The system of claim 1, wherein the one or more mode suppressing coaxial cables are configured to reduce power dissipation associated with the transport of the high bandwidth communications.

6. The system of claim 1, wherein the one or more mode suppressing coaxial cables comprise one or more amplifiers configured to compensate for signal loss associated with the transport of the high bandwidth communications.

7. The system of claim 6, wherein the one or more mode suppressing coaxial cables comprise one or more electrical supply lines configured to supply power to the one or more amplifiers.

8. The system of claim 7, wherein the supplied power comprises direct current (DC) power.

9. The system of claim 6, wherein the one more amplifiers are low power dissipation amplifiers.

10. The system of claim 1, wherein the one or more mode suppressing coaxial cables may be configured in a separable ribbon format.

11. A method, comprising:
at a data center comprising a network switch configured to communicate high bandwidth communications to one or more servers and one or more mode-suppressing coaxial cables coupling the network switch to the one or more servers:
transporting the high bandwidth communications between the network switch and the one or more servers using the one or more mode-suppressing coaxial cables.

12. The method of claim 11, wherein transporting comprises using one of single-ended form and differential form to transport the high bandwidth communications.

13. The method of claim 11, transporting comprises using resistive mode suppression to transport the high bandwidth communications.

14. The system of claim 11, wherein the one or more mode suppressing coaxial cables are configured to reduce power dissipation associated with the transport of the high bandwidth communications.

15. The system of claim 11, wherein the one or more mode suppressing coaxial cables comprise one or more amplifiers configured to compensate for signal loss associated with the transport of the high bandwidth communications.

16. The system of claim 15, wherein the one or more mode suppressing coaxial cables comprise one or more electrical supply lines configured to supply power to the one or more amplifiers.

17. The system of claim 16, wherein the supplied power comprises direct current (DC) power.

18. The system of claim 15, wherein the one more amplifiers are low power dissipation amplifiers.

19. The system of claim 1, wherein the one or more mode suppressing coaxial cables are configured in a separable ribbon format.

20. A cable assembly comprising:
first and second adapter modules each configured to couple with a communication port of at least one of a network switch and a server;
a first plurality of mode-suppressed coaxial cables coupled between the first adapter module and a plurality of amplifiers; and
a second plurality of mode-suppressed coaxial cables coupled between the plurality of amplifiers and the second adapter module, wherein:
each of the plurality of amplifiers is a low noise amplifier and configured to provides roll-off compensation; and
the cable assembly is configured to communicate high bandwidth communications between the network switch and the server.
